(19) United States
(12) Patent Application Publication
(10) Pub. No.: US 2011/0257969 A1
(43) Pub. Date: Oct. 20, 2011

(54) MAIL RECEIPT APPARATUS AND METHOD BASED ON VOICE RECOGNITION

(75) Inventor: Hea Won LEE, Daejeon (KR)

(73) Assignee: Electronics and Telecommunications Research Institute, Daejeon (KR)

(21) Appl. No.: 13/085,655

(22) Filed: Apr. 13, 2011

(30) Foreign Application Priority Data
Apr. 14, 2010 (KR) 10-2010-0034231

(51) Int. Cl. G10L 15/00

(52) U.S. Cl. 704/231; 704/E15.001

(57) ABSTRACT

A mail receipt method based on voice recognition, includes receiving input voice data required for an mail receipt; and recognizing information about the mail receipt from the received input voice data. Further, the mail receipt method based on the voice recognition includes storing the recognized information about the mail receipt to complete the mail receipt.

### CROSS-REFERENCE TO RELATED APPLICATION(S)

The present invention claims priority of Korean Patent Application No. 10-2010-0034231, filed on Apr. 14, 2010, which is incorporated herein by reference.

### FIELD OF THE INVENTION

The present invention relates to a mail receipt apparatus and method; and more particularly to, a mail receipt apparatus and method for inputting vocal mail receipt information and receiving mail by recognizing the input vocal mail information.

### BACKGROUND OF THE INVENTION

As well known, mail may be classified into regular mail information about a sender and an addressee of which is registered by a post clerk when the regular mail is received and a registered mail information about a sender and an addressee of which should be registered by the post clerk. In the regular mail, the receipt is completed by attaching a post stamp to the regular mail without the receipt procedure and putting the regular mail into a mailbox. However, the receipt of the registered mail is completed when the post clerk should record the information.

Particularly, mail is received by a post staff at a receipt desk, by self-service, and call package receipt. In the call package receipt, a mail receipt staff receives paper, on which address of a sender and an addressee are written, from a customer at the site where the customer calls. Then, the mail receipt staff writes the information of a sender such as a name, a telephone number, a mobile phone number, a zip code of the sender, the information of an addressee such as a name, a telephone number, a mobile phone number, a zip code of the addressee on package receipt paper with three pages. Further, the mail receipt staff writes information about a package such as content of the package, weight, size, fee, caution and a delivery method, payment information, a name of the mail receipt staff, and a name of a post office on package receipt paper with three pages. Thereafter, a first page of the package receipt paper to the package is attached, a second page is provided to the customer, and a third page is kept for a post office, and then the mail receipt is completed.

As such, since the call package receipt depends on hand writing on paper, it is inconvenient and needs paper fee. Moreover, it is inconvenient, after returning to the post office, to input information of several hundred sheets of the hand writing mail receipt paper per a day into a post system, to compare the package to be real, and to receive package fee.

For these reasons, a technique for inputting receipt information using voice recognition when receiving mail is proposed. In this case, a voice recognition system is installed to a mobile receipt terminal such as PDA, a mobile phone, and the lime in order to perform mail receipt. However, since it is difficult for the mobile receipt terminal having low computing performance to perform voice recognition using a high capacity voice feature POI database including geometric address, a zip code, and the like, the mobile receipt terminal is hardly applied to the mail receipt.

### SUMMARY OF THE INVENTION

In view of the above, the present invention provides a mail receipt apparatus for constructing voice point of interest (hereinafter, referred to ‘POI’) database for receipt of mail by recognizing voice in a mobile receipt terminal and for recognizing information about mail receipt to perform mail receipt effectively.

In accordance with a first aspect of the present invention, there is provided a mail receipt method based on voice recognition including: receiving input voice data required for an mail receipt; recognizing information on the mail receipt from the received input voice data; and storing the recognized information on the mail receipt to complete the mail receipt.

In accordance with a second aspect of the present invention, there is provided a mail receipt apparatus based on voice recognition. The mail receipt apparatus based on the voice recognition includes a voice input block for inputting voice for receipt of mail; a receipt information recognition block for recognizing mail receipt information from a voice data transmitted from the voice input block; and a receipt block for storing the recognized mail receipt information to perform mail receipt.

In accordance with an embodiment of the present invention, mail receipt information generated when receiving mail is input to a mail receipt device such as PDA, a mobile phone, and the like, with voice such that corresponding mail receipt information is transformed into text. The information may be provided to a customer and a post office in real time. Since the mail receipt become convenient and simple, costs may be reduced, service quality against customers may be improved, the mail receipt staff needs not to carry hand writing paper, and inconvenience for memorizing zip code of all over the country and/or for searching a zip code book may be reduced.

### BRIEF DESCRIPTION OF THE DRAWINGS

The objects and features of the present invention will become apparent from the following description of embodiments given in conjunction with the accompanying drawings, in which:

FIG. 1 is a block diagram illustrating a mail receipt apparatus for receiving mail by recognizing voice using a voice POI database in accordance with an embodiment of the present invention;

FIG. 2 is a block diagram illustrating a receipt information recognition block for recognizing various types of information about mail receipt using various voice feature vector databases and various information databases in accordance with the embodiment of the present invention;

FIG. 3 is a block diagram illustrating an address acquisition unit for acquiring address information from voice data in accordance with the embodiment of the present invention;

FIG. 4 is a block diagram illustrating a zip code acquisition unit for acquiring zip code information from voice data in accordance with the embodiment of the present invention;

FIG. 5 is a block diagram illustrating a telephone number acquisition unit for acquiring telephone number information from the voice data in accordance with the embodiment of the present invention;

FIG. 6 is a block diagram illustrating a mail information acquisition unit for acquiring mail information from the voice data in the embodiment of the present invention;

FIG. 7 is a block diagram illustrating a payment information acquisition unit for acquiring payment information from the voice data in accordance with the embodiment of the present invention;

FIG. 8 is a flowchart illustrating mail receipt through voice recognition using the voice POI database in accordance with the embodiment of the present invention;

FIG. 9 is a flow chart illustrating acquisition of address information for receipt of mail in accordance with another embodiment of the present invention;

FIG. 10 is a flow chart illustrating acquisition of zip code information for receipt of mail in accordance with still another embodiment of the present invention;

FIG. 11 is a flow chart illustrating acquisition of a telephone number for receipt of mail in accordance with still another embodiment of the present invention;

FIG. 12 is a flow chart illustrating acquisition of mail information for receipt of mail in accordance with still another embodiment of the present invention;

FIG. 13 is a flow chart illustrating acquisition of payment information for receipt of mail in accordance with still another embodiment; and

FIG. 14 is a view illustrating an example of displayed image of mail receipt in accordance with an embodiment of the present invention.

### DETAILED DESCRIPTION OF THE EMBODIMENTS

Hereinafter, embodiments of the present invention will be described in detail with reference to the accompanying drawings which form a part hereof.

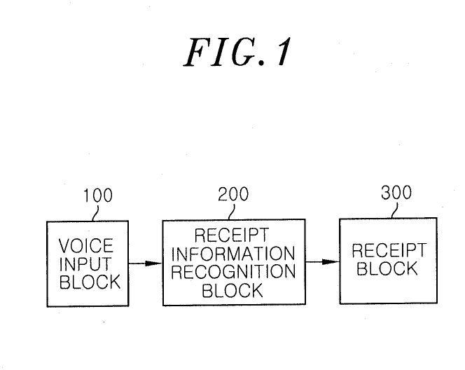

FIG. 1 is a block diagram illustrating a mail receipt apparatus for receiving mail by recognizing voice using a voice POI database in accordance with an embodiment of the present invention. The mail receipt apparatus may include a voice input block 100, a receipt information recognition block 200, and a receipt block 300.

Referring to FIG. 1, the voice input block 100 is a device to input voice for receipt of mail and includes a microphone. When a voice such as address, a zip code, a telephone number, main information, and payment information for receiving mail is input, the voice input block 100 transmits the voice data to the receipt information recognition block 200.

The receipt information recognition block 200 recognizes various types of information such as addressee information, sender information, mail item information, and payment information required to receive the mail using a voice POI database. When the voice data is transmitted, the receipt information recognition block 200 extracts an address voice feature vector from corresponding voice data, matches a feature vector pattern using an address feature vector database, and extracts an address word. Then, the receipt information recognition block 200 searches for the extracted address word in a postal address information database, and acquires corresponding searched address information such as address information of addressee and address information of a sender.

When the voice data for the receipt of mail is transmitted, the receipt information recognition block 200 extracts a zip code voice feature vector from corresponding voice data, matches a feature vector pattern using a regional zip code feature vector database, and extracts a zip code number. Then, the receipt information recognition block 200 searches for the extracted zip code number in a zip code information database, and acquires corresponding searched zip code information such as zip code information of an addressee and zip code information of a sender.

When the voice data for the receipt of mail is transmitted, the receipt information recognition block 200 extracts a telephone number voice feature vector from corresponding voice data, matches a feature vector pattern using a telephone number feature vector database, and extracts a telephone word (number). Then, the receipt information recognition block 200 searches for the extracted telephone word in a customer information database, and acquires corresponding searched telephone number information such as telephone number information of an addressee and telephone information of a sender.

When the voice data for the receipt of mail is transmitted, the receipt information recognition block 200 extracts a mail information voice feature vector from corresponding voice data, matches a feature vector pattern using a mail information feature vector database, and extracts a mail information word. Then, the receipt information recognition block 200 searches for the extracted mail information word in a mail information database, and acquires corresponding searched mail information such as information of a mailing item.

When the voice data for the receipt of mail is transmitted, the receipt information recognition block 200 extracts a payment information feature vector from corresponding voice data, matches a feature vector pattern using a payment information feature vector database, and acquires extracted payment information.

Next, the receipt information recognition block 200 recognizes the address information, the zip code information, the telephone number information, the mail information, and the payment information, which are acquired for the receipt of mail as mail receipt information, and outputs the recognized mail receipt information to the receipt block 300. The mail receipt information may include addressee information, sender information, mail information, and payment information.

The receipt block 300 displays the mail receipt information output from the receipt information recognition block 200 and stores the corresponding mail receipt information when a mail receiver input a confirmation key, resulting in finishing the mail receipt.

In the above-mentioned embodiment of the present invention, the present invention has been described such that the address information and the zip code information are respectively acquired by the receipt information recognition block 200. However, since the address and the zip code can be built into a database as interconnected information, a address information database and a zip code information database are built into a single database to search for the address word and the zip code number together. Consequently, the address information and the zip code information can be acquired at the same time.

The voice POI database may be selectively constructed from various databases used for the mail receipt. The various database used for the mail receipt includes, e.g., the address feature vector database, the address information database, the regional zip code information feature vector database, the zip code information database, the telephone number feature vector database, the customer information database, the mail information feature vector database, the mail information database, and the payment information database.

Thus, in the mail receipt apparatus, various voice feature vector databases and information databases for acquiring the address information, the zip code information, the telephone number information, the mail information, and the payment information so that information for the mail receipt can be easily acquired.

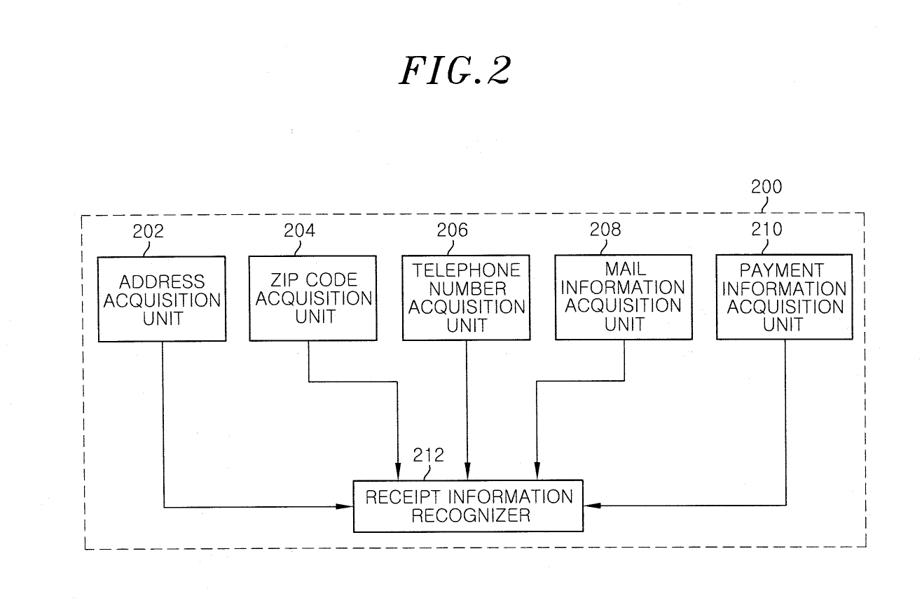

FIG. 2 is a block diagram illustrating the receipt information recognition block for recognizing various types of information about mail receipt using various voice feature vector databases and various information databases in the embodiment of the present invention. The receipt information recognition block 200 may include an address acquisition unit 202, a zip code acquisition unit 204, a telephone number acquisition unit 206, a mail information acquisition unit 208, a payment information acquisition unit 210, and a receipt information recognizer 212.

Referring to FIG. 2, when address input voice data on an addressee or a sender required for the mail receipt is transmitted from the voice input block 100, the address acquisition unit 202 extracts an address voice feature vector from corresponding voice data, matches a feature vector pattern using an address feature vector database, and extracts an address word. Then, the address acquisition unit 202 searches for the extracted address word in the address information database, and acquires corresponding address information. That is, the address acquisition unit 202 extracts the address voice feature vector from the transmitted address input voice data, separates the address voice feature vector according to vocalization methods. Then, the address acquisition unit 202 matches the separated address voice feature vector, e.g., a corresponding address voice feature vector pattern in the address feature vector database including a street name vector, a street/district name feature vector, and a street/district/city (state) name feature vector according to the number of words. Thereafter, the address acquisition unit 202 extracts the address words such as a street name, street/district name words, and street/district/city (state) name words, and searching for the address words in the address information database built in connection with addresses and zip codes. As a result, the address acquisition unit 202 acquires the address information about an addressee or a sender. The zip code acquisition unit 204, when zip code input voice data on an addressee or a sender for the mail receipt is transmitted from the voice input block 100, extracts a zip code voice feature vector from corresponding voice data, and matches a feature vector pattern using a state zip code feature vector database. Then, the zip code acquisition unit 204 extracts a zip code number, searches for the extracted zip code number in the zip code information database, and acquires corresponding zip code information. That is, the zip code acquisition unit 204 extracts the zip code voice feature vector from the transmitted zip code input voice data, and separates a first number from the extracted zip code voice feature vector. Then, the zip code acquisition unit 204 classifies a pattern of the extracted zip code voice feature vector according to the separated first number of the zip code voice feature vector in a zip code feature vector database. Here, the zip code feature vector database includes, e.g., a Seoul feature vector, a Gangwon feature vector, a Chungcheong feature vector, a Gyeongin feature vector, a Jeolra feature vector, a Gyeongnam feature vector, and a Gyeongbuk feature vector. Thereafter, the zip code acquisition unit 204 matches the pattern of the corresponding zip code voice feature vector, extracting the number of a state zip code according to the matched pattern, and searching for the zip code in the zip code information database built in connection with addresses and zip codes. Consequently, the zip code acquisition unit 204 acquires the zip code information about an addressee or a sender.

The telephone number acquisition unit 206, when telephone number input voice data on an addressee or a sender for the mail receipt is transmitted from the voice input block 100, extracts a telephone number voice feature vector from corresponding voice data, and matches a feature vector pattern using a telephone number feature vector database. Then, the telephone number acquisition unit 206 extracts a telephone word (number), searches for the extracted telephone number word in the customer information database, and acquires corresponding telephone number information. That is, the telephone number acquisition unit 206 extracts the telephone number voice feature vector from the transmitted telephone number input voice data, and separates the extracted telephone number voice feature vector into three words. Then, the telephone number acquisition unit 206 matches a pattern of the separated telephone number voice feature vector in a telephone number feature vector database. Here, telephone number feature vector database includes, e.g., a region/mobile phone number feature vector, an area number feature vector, and a telephone number feature vector, according to a corresponding word. Thereafter, the telephone number acquisition unit 206 extracts a telephone number word such as a region/mobile phone number, an area number, and a telephone number according to the matched pattern, and searches for the telephone number word in the telephone number information database including a customer name, a customer telephone number, and the like. Consequently, the telephone number acquisition unit 206 acquires the telephone information about an addressee or a sender.

The mail information acquisition unit 208, when mail information input voice data for the mail receipt is transmitted from the voice input block 100, extracts a mail information voice feature vector from corresponding voice data, and matches a feature vector pattern using a mail information feature vector database. Then, the mail information acquisition unit 208 extracts a mail information word, searches for the extracted mail information word in the mail information database, and acquires corresponding mail information. That is, the mail information acquisition unit 208 extracts the mail information voice feature vector from the transmitted mail information input voice data, and separates the mail information voice feature vector into five words, e.g., content of a package, a service type, weight, size, an delivery method. Thereafter, the mail information acquisition unit 208 matches a pattern of the separated mail information feature vector in a mail information vector database. Here, the mail information vector database includes, e.g., a package content feature vector, a service feature vector, a weight feature vector, a size feature vector, a delivery method feature vector and the like, according to a corresponding word. Thereafter, the mail information acquisition unit 208 extracts a main information word, e.g., content of package, a service type, weight, a size, a delivery method and the like according to the matched pattern, and searches for the mail information word in the mail information database. Here, the mail information database includes, e.g., a package content, a service type, weight, a size, a delivery method and the like. As a result, the mail information acquisition unit 208 acquires the mail information about an addressee or a sender.

The payment information acquisition unit 210, when voice data for the mail receipt is transmitted from the voice input block 100, extracts a payment information voice feature vector from corresponding voice data, matches a feature vector pattern using a payment information feature vector database, and acquires extracted payment information. That is, the payment information acquisition unit 210 extracts the payment information voice feature vector from the transmitted payment information input voice data, and separates the payment information voice feature vector into several words, e.g., immediate payment, postpaid, subsequent payment, unpaid, a credit card and the like. Then, the payment information acquisition unit 210 matches a pattern of the separated payment information feature vector in a payment information vector database according to a corresponding word, and acquires the corresponding payment information by extracting a payment information word, e.g., immediate payment, postpaid, subsequent payment, unpaid, a credit card and the like according to the matched pattern. As a result, the payment information acquisition unit 210 acquire the corresponding payment information.

Next, the receipt information recognizer 212 recognizes various information including the address information, the zip code information, the telephone number information, the mail information, the payment information and the like, as the mail receipt information to output the recognized mail receipt information to the receipt block 300. Here, the various information is acquired for the mail receipt by the address acquisition unit 202, the zip code acquisition unit 204, the telephone number acquisition unit 206, the main information acquisition unit 208, and the payment information acquisition unit 210.

In this embodiment, the address information and the zip code information are acquired by the address acquisition unit 202 and the zip code acquisition unit 204, respectively. However, since the address and the zip code are built in a database as interconnected information, the address information database is integrated with the zip code information database and the address word is searched for together with the zip code number in the database. Consequently, the address information and the zip code information of an addressee or a sender may be acquired at the same time.

Thus, the voice feature vector is extracted from the input voice data transmitted for the mail receipt, the feature pattern is matched using the respective feature vector database. Thereafter, the address information, the zip code information, the telephone number information, the mail information, and the payment information are acquired from the respective information databases so that the mail receipt information including such information may be effectively recognized.

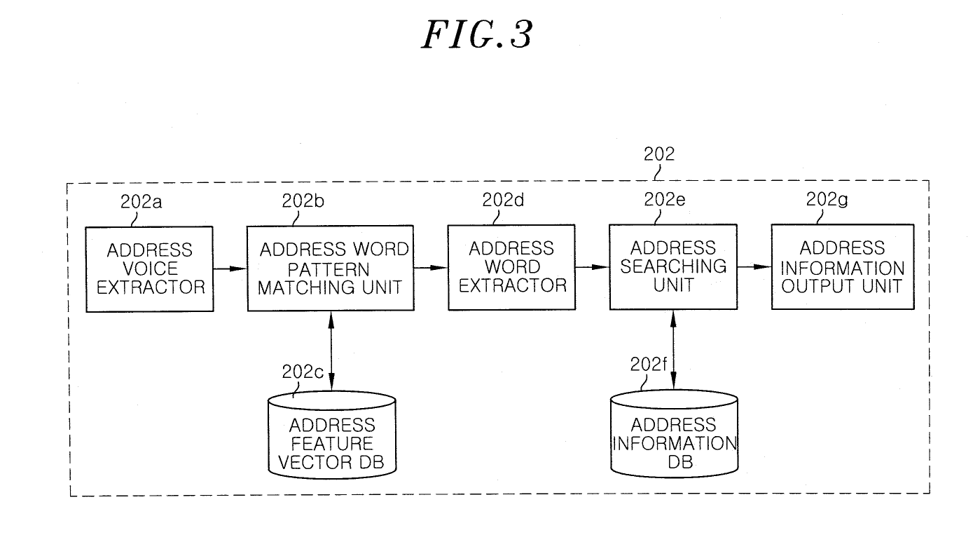

FIG. 3 is a block diagram illustrating the address acquisition unit for acquiring address information from voice data in the embodiment of the present invention. The address acquisition unit 202 may include an address voice extractor 202a, an address word pattern matching unit 202b, an address feature vector database (DB) 202c, an address word extractor 202d, an address searching unit 202e, an address information database (DB) 202f, and an address information output unit 202g.

Referring to FIG. 3, the address voice extractor 202a extracts an address voice feature vector from the address input voice data on an addressee or a sender transmitted from the voice input block 100.

The address word pattern matching unit 202b separates the extracted address voice feature vector into a single word address voice feature vector, a two-word voice feature vector, and a three-word voice feature vector according to vocalization methods. Further, the address word pattern matching unit 202b matches patterns of the separated address voice feature vectors according to the number of words in the address feature vector database 202c including a street name feature vector, a street/district name feature vector, and the street/district/city (state) name feature vector.

The address word extractor 202d extracts an address word such as a street (block) name, a street/district (block/city area) name, and a street/district/city (state) (block/city area/country) name according to the matched pattern. A plurality of same street names may be extracted when the address word is extracted by referring a street (block) name feature vector database. On the other hand, a single street name may be extracted when the address word is extracted by referring a street/district (block/city area) name feature vector database or a street/district/city (state) (block/city area/country) name feature vector database.

The address searching unit 202e searches for the extracted address word in an address information database 202f built in interconnecting the address with a zip code. Since the address information database 202f is built by connecting the address with the zip code, the address may be searched for and extracted with the zip code.

The address information output unit 202g acquires the searched address as address information about an addressee or a sender and outputs the acquired address information to the receipt information recognizer 212. The address information output unit 202g may acquire more precise address information by displaying the acquired address information to allow a mail receipt staff to confirm.

Thus, the address acquisition unit may effectively acquire the address information from the input voice data through the process of extracting the voice feature vector from the input voice data, extracting the address word by words using the address feature vector database, and searching for the extracted address word in the address information database to acquire the address information.

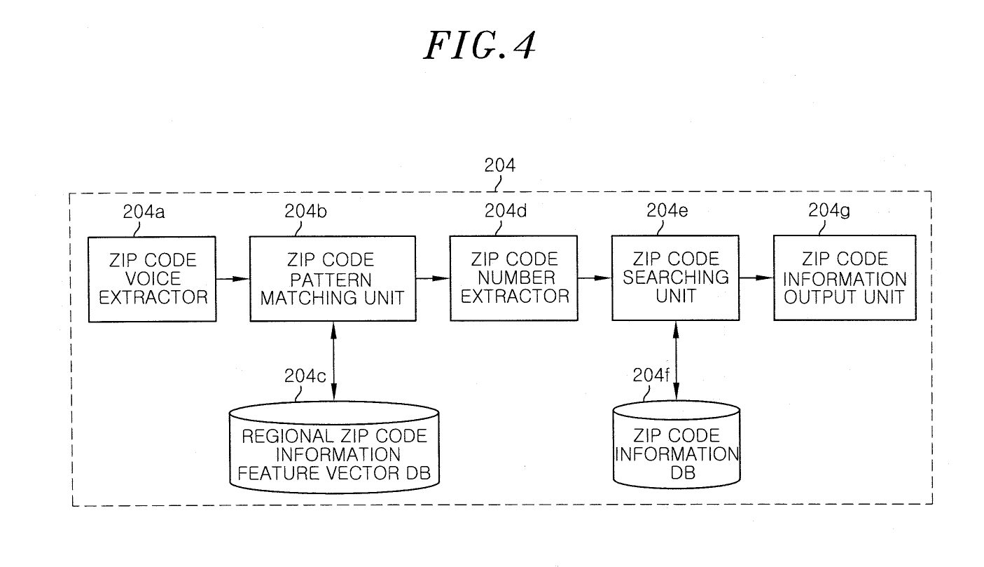

FIG. 4 is a block diagram illustrating a zip code acquisition unit for acquiring zip code information from voice data in the embodiment of the present invention. The zip code acquisition unit 204 may include a zip code voice extractor 204a, a zip code pattern matching unit 204b, a regional zip code information feature vector database (DB) 204c, a zip code number extractor 204d, a zip code searching unit 204e, a zip code information database (DB) 204f, and a zip code information output unit 204g.

Referring to FIG. 4, the zip code voice extractor 204a extracts the zip code voice feature vector from the zip code input voice data on an addressee or a sender transmitted from the voice input block 100.

The zip code pattern matching unit 204b separates a first number of the extracted zip code voice feature vector, and matches a pattern of a corresponding zip code voice feature vector by classifying the extracted first number of the zip code voice feature vector by regions in the zip code feature vector database 204c. Here, the zip code feature vector database 204c includes, e.g., a Seoul feature vector, a Gangwon feature vector, a Chungcheong feature vector, a Gyeonin feature vector, a Jeolra feature vector, a Gyeongnam feature vector, a Gyeongbuk feature vector and the like. For example, ‘1’ is assigned to Seoul region, ‘2’ is assigned to Gangwon region, ‘3’ is assigned to Chungcheong region, ‘4’ is assigned to Gyeongin region, ‘5’ is assigned to Jeolra region, ‘6’ is assigned to Gyeongnam region, and ‘7’ is assigned to Gyeongbuk region.

The zip code number extractor 204d extracts the number of a regional zip code according to the matched pattern. In this case, about five numbers of zip codes having high similarities may be extracted.

The zip code searching unit 204e searches for a zip code in the zip code information database built by connecting a zip code with an address using the extracted number. Since the zip code information database 204f is built by connecting a zip code with an address, the zip code may be searched for and extracted together with the address.

The zip code information output unit 204g acquires the searched zip code as zip code information about an addressee or a sender to output the acquired zip code information to the receipt information recognizer 212. When the acquired zip code information is display to allow a mail receipt staff to confirm, more precise zip code information may be acquired.

Thus, the zip code acquisition unit extracts the voice feature vector from the input voice data, extracts the zip code number using the regional feature vector database, and searches for the extracted zip code number in the zip code information database to acquire the zip code information. As a result, the zip code acquisition unit can effectively acquire the zip code information from the input voice data.

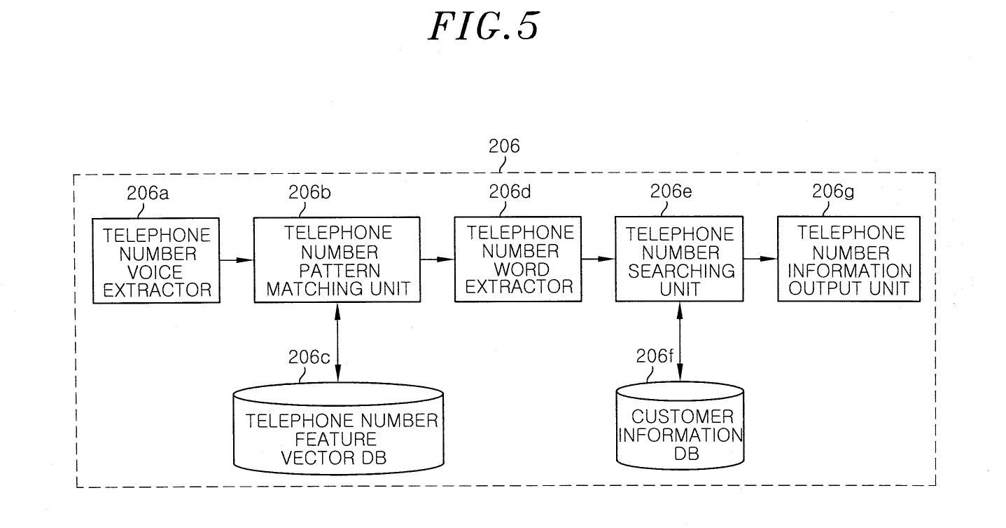

FIG. 5 shows a block diagram of the telephone number acquisition unit for acquiring the telephone number information from the voice data. The telephone number acquisition unit 206 may include a telephone number voice extractor 206a, a telephone number pattern matching unit 206b, a telephone number feature vector database (DB) 206c, a telephone number word extractor 206d, a telephone number searching unit 206e, a customer information database (DB) 206f, and a telephone number information output unit 206d.

Referring to FIG. 5, the telephone number voice extractor 206a extracts a telephone number voice feature vector from the telephone number input voice data on an addressee or a sender transmitted from the voice input block 100.

The telephone number pattern matching unit 206b separates the extracted telephone number voice feature vector into three word telephone number voice feature vectors and matches patterns of the separated telephone feature vectors according to corresponding words in the telephone number feature vector database 206c. Here, the telephone number feature vector database 206c includes, e.g., a region/mobile phone number feature vector, an area number feature vector, and telephone number feature vector. In the region/mobile phone number feature vector, the region/mobile phone number may be classified into Seoul ‘02’, Gyeonggi ‘031’, Incheon ‘032’, Gangwon ‘033’, Chungnam ‘041’, Daejeon ‘042’, Chungbuk ‘043’, Busan ‘051’, Wulsan ‘052’, Daegu ‘053’, Gyeongbuk ‘054’, Gyeongnam ‘055’, Jeonnam ‘061’, Gwangju ‘062’, Jeonbuk ‘063’, Jeju ‘064’, and mobile phone ‘010, 011, 016, 017, and 019’.

Next, the telephone number word extractor 206d extracts a telephone number word (number) including the region/mobile phone number, the area number, and the telephone number according to the matched pattern. The telephone number word may be extracted in the form of ‘region/mobile phone number-area number-telephone number’. The first word of the telephone number word is used to distinguish a wire telephone from a wireless telephone. When the first word of the telephone number word is a regional number, the regional number word is extracted using a regional number feature vector database. Further, when the first word of the telephone number word is a number indicating a communication company or a mobile telephone communication company, a mobile phone number is extracted using a mobile phone feature vector database.

A second word of the telephone number word is used to distinguish an area number such that the area number may be extracted according to a three-digit word, a four-digit word, and the like. A third word of the telephone number word is used to distinguish the telephone number such that the telephone number may be extracted according to the four-digit word. Thus, the extracted region/mobile phone number-area number-telephone number may be used to several telephone numbers having relatively high similarities.

The telephone number searching unit 206e searches for the telephone number in the customer information database 206f including a customer name, a customer telephone number, and the other using the extracted telephone word.

The telephone number information output unit 206g acquires the searched telephone number as telephone number information about an addressee or a sender and outputs the telephone number information to the receipt information recognizer 212. When the acquired telephone number is displayed to allow a mail receipt staff to confirm, more precise telephone number information may be acquired.

Thus, the telephone number acquisition unit extracts the voice feature vector from the input voice data, extracts the telephone word (number) by numbers using the feature vector database, and searches for the telephone word in the customer information database to acquire the telephone number information so that the telephone number information may be effectively acquired from the input voice data.

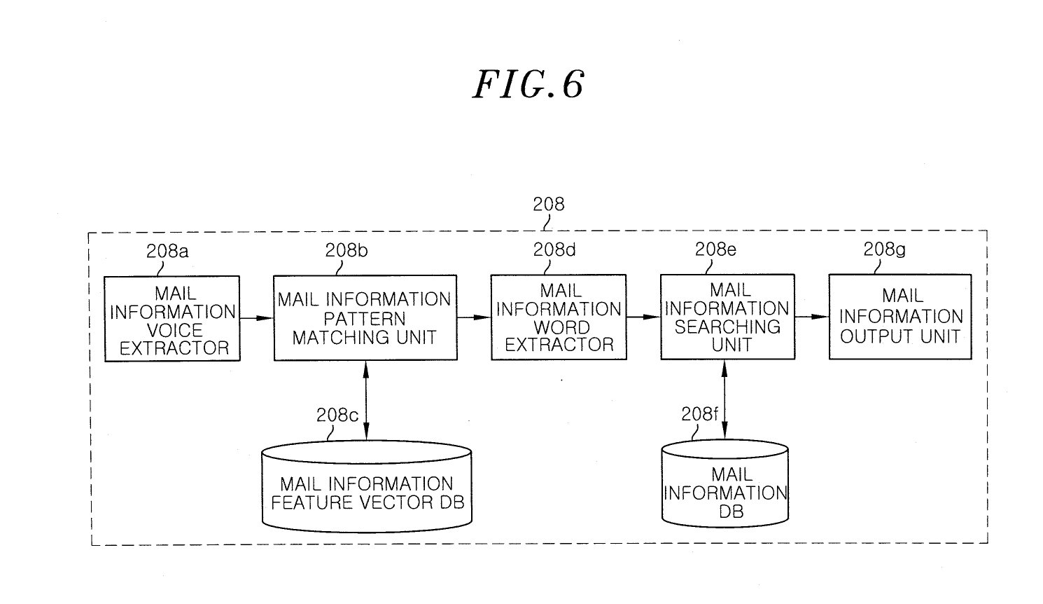

FIG. 6 shows a block diagram illustrating the mail information acquisition unit for acquiring mail information from the voice data in the embodiment of the present invention. The mail information acquisition unit 208 may include a mail information voice extractor 208a, a mail information pattern matching unit 208b, a mail information feature vector database (DB) 208c, a mail information word extractor 208d, a mail information searching unit 208e, a mail information database (DB) 208f, and a mail information output unit 208g.

Referring to FIG. 6, the mail information voice extractor 208a extracts the mail information voice feature vector from mail information input voice data transmitted from the voice input block 100.

The mail information pattern matching unit 208b separates the extracted mail information voice feature vector into five words such as content of a package, a service type, weight, a size, and a delivery method. Then, the mail information pattern matching unit 208b matches a pattern of the separated mail information voice feature vector in the mail information feature vector database 208c including a package content feature vector, a service type feature vector, a weight feature vector, a size feature vector, and a delivery method feature vector according to a corresponding word. The mail information pattern matching unit 208b may match the pattern through the feature vectors on continuous voice data including package content, a service type, weight, a size, and a delivery method.

The mail information word extractor 208d extracts words related to the mail information including package content, a service type, weight, a size, and a delivery method according to the matched pattern. The extracted words are displayed to allow a mail receipt staff to confirm so that a more precise word may be extracted.

The mail information searching unit 208e searches for a word related to the mail information in the mail information database 208f including package content, a service type, weight, a size, and a delivery method using the extracted word.

The mail information output unit 208g acquires the searched word as the mail information and outputs the acquired mail information to the receipt information recognizer 212.

Thus, the mail information acquisition unit extracts the voice feature vector from the input voice data, extracts a word related to the mail information using the mail information feature vector database, and acquires the mail information by searching for the extracted word in the mail information database. Consequently, the mail information acquisition unit may effectively acquire the mail information from the input voice data.

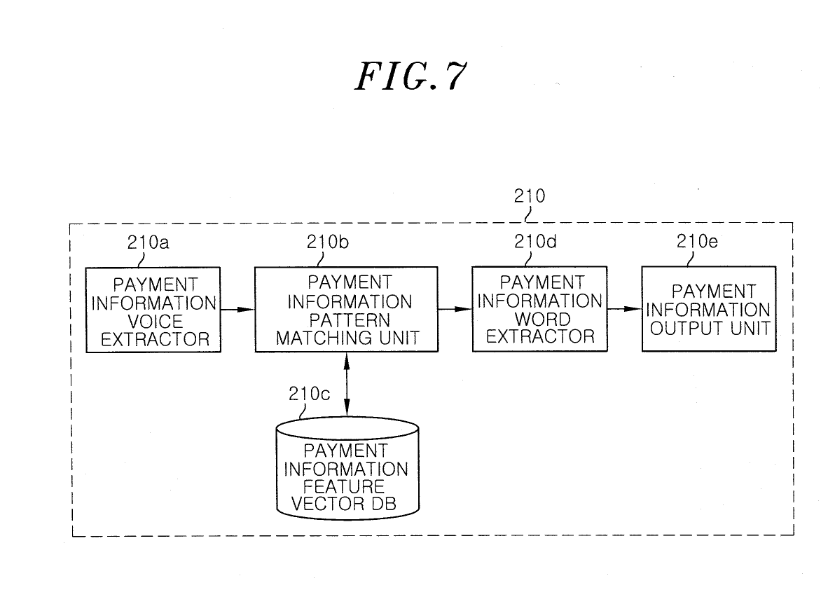

FIG. 7 shows a block diagram illustrating the payment information acquisition unit for acquiring payment information from the voice data in the embodiment of the present invention. The payment information acquisition unit 210 may include a payment information voice extractor 210a, a payment information patter matching unit 210b, a payment information feature vector database (DB) 210c, a payment information word extractor 210d, and a payment information output unit 210e.

Referring to FIG. 7, the payment information voice extractor 210a extracts payment information voice feature vector from payment information input voice data transmitted from the voice input block 100.

The payment information pattern matching unit 210b matches a pattern of the extracted payment information voice feature vector including several words such as immediate payment, postpaid, subsequent payment, unpaid, and a credit card according to a corresponding word in the payment information feature vector database 210c including an immediate payment feature vector, a postpaid feature vector, a subsequent payment feature vector, an unpaid feature vector, and a credit card feature vector.

The payment information word extractor 210d extracts a word related to the payment information including immediate payment, postpaid, subsequent payment, unpaid, and a credit card according to the matched pattern. The extracted word is displayed to allow a mail receipt staff to confirm so that a more precise word may be extracted.

The payment information output unit 210e acquires the extracted word as the payment information to output the acquired payment information to the receipt information recognizer 212.

Thus, the payment information acquisition unit extracts the voice feature vector from the input voice data and acquires the payment information by extracting the word related to the payment information using the payment information feature vector database so that the payment information may be effectively acquired from the input voice data.

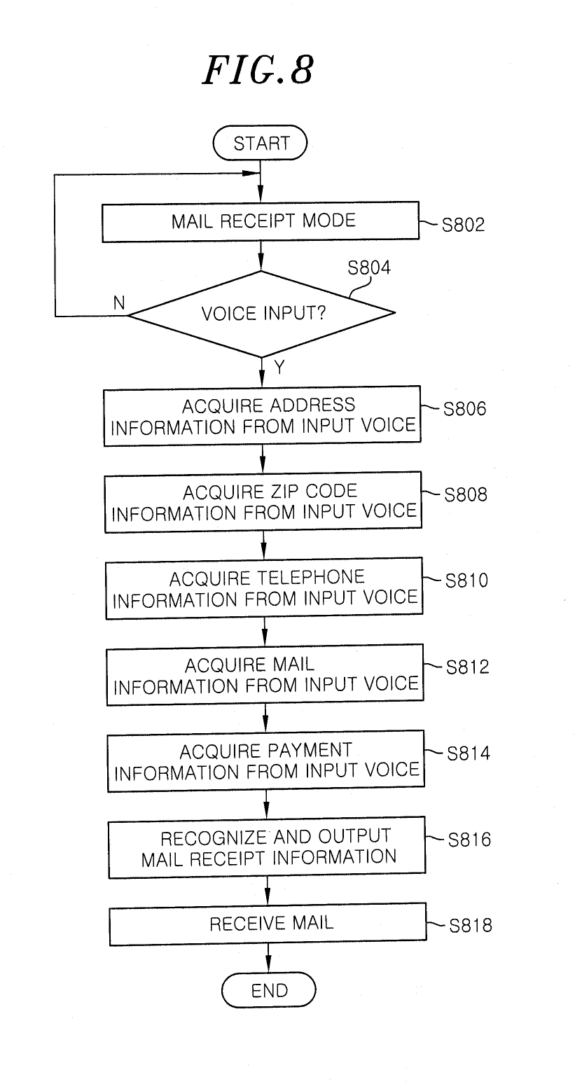

FIG. 8 is a flow chart illustrating the mail receipt performed by recognizing voice using the voice POI database in accordance with an embodiment of the present invention.

Referring to FIG. 8, the mail receipt apparatus becomes a mail receipt mode in step S802, the voice input block 100 checks whether voice including address, a zip code, a telephone number, mail information, and payment information is input for the mail receipt in step S804.

When the voice for the mail receipt is input as a result of the check in step S804, the voice data is transmitted to the mail information recognizing block 200. Then, the address acquisition unit 202 of the receipt information recognizing block 200 acquires address information about an addressee or a sender from the corresponding voice data in step S806. The acquisition of address information may be performed by extracting the address voice feature vector from corresponding voice data, by matching the feature vector pattern using the address feature vector database, by extracting the address word, by searching for the extracted address word in the address information database, and acquiring the searching address information.

When the voice data for the mail receipt is transmitted, the zip code acquisition unit 204 of the receipt information recognition block 200 acquires the zip code information about an addressee or a sender from corresponding voice data in step S808. The acquisition of the zip code information may be performed as follows. For example, the zip code voice feature vector from corresponding voice data is extracted, the feature vector pattern using the regional zip code feature vector database is matched, the zip code number is extracted, the extracted zip code number in the zip code information database is searched, and the searched zip code information is acquired.

In this embodiment, it is described that the address acquisition unit 202 and the zip code acquisition unit 204 of the receipt information recognition block 200 acquire the address information and the zip code information respectively. However, since address and the zip code are interconnected information and may be built into a database, the address information database and the zip code information database are integrated into a single database to search for the address word and the zip code number at the same time. As a result, the address information and the zip code information may be acquired simultaneously.

When the voice data for the mail receipt is transmitted, the telephone number acquisition unit 206 of the receipt information recognition block 200 acquires the telephone number information about an addressee or a sender in step S810. The acquisition of the telephone number information may be performed as follows. For example, the telephone number voice feature vector from corresponding voice data is extracted, the feature vector pattern using the telephone number feature vector database is matched, the telephone number word (number) is extracted, the extracted telephone number word in the customer information database is searched, and the searched telephone number information is acquired.

When the voice data for the mail receipt is transmitted, the mail information acquisition unit 208 of the receipt information recognition block 200 acquires the mail information from corresponding voice data in step S812. The acquisition of the mail information may be performed as follows. For example, the mail information voice feature vector from corresponding voice data is extracted, the feature vector pattern using the mail information feature vector database is matched, the mail information word is extracted, the extracted mail information word in the mail information database is searched, and the searched mail information is acquired.

When the voice data for the mail receipt is transmitted, the payment information acquisition unit 210 of the receipt information recognition block 200 acquires the payment information from corresponding voice data in step S814. The acquisition of the payment information may be performed by extracting the payment information voice feature vector from corresponding voice data, by matching the feature vector pattern using the payment information feature vector database, and by acquiring the extracted payment information.

The receipt information recognizer 212 of the receipt information recognition block 200 recognizes the address information, the zip code information, the telephone number information, the mail information, and the payment information which are acquired for the mail receipt as the mail receipt information in step S816.

The voice POI database includes, e.g., the address feature vector database, the address information database, the regional zip code information feature vector database, the zip code information database, the telephone number feature vector database, the customer information database, the mail information feature vector database, the mail information database, the payment information database and the like. Further, the voice POI database may be selectively constructed from various databases used for a mail receipt.

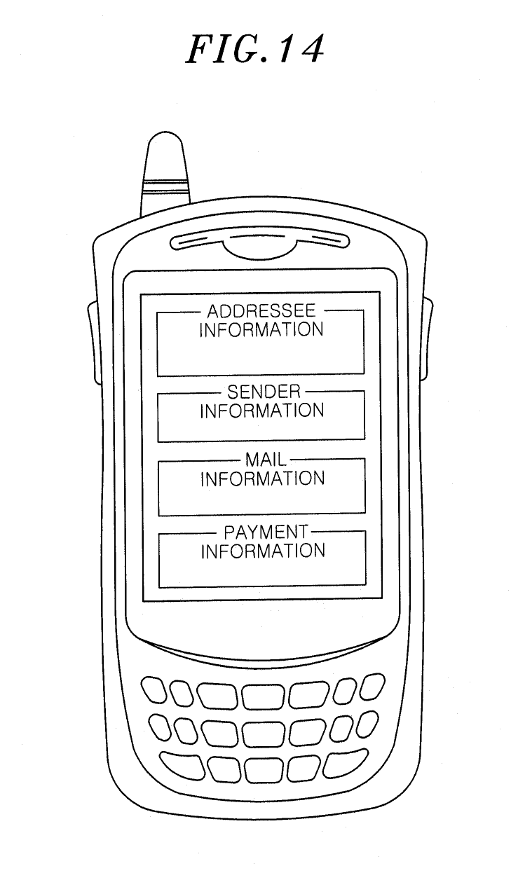

The receipt block 300 completes the mail receipt by displaying the mail receipt information transmitted from the receipt information recognition block 200 and by storing corresponding mail receipt information according to an input of a confirm key from the mail receipt staff in step S818. FIG. 14 is a view illustrating an example of a result displayed after completing the mail receipt according to an embodiment of the present invention. As illustrated in FIG. 14, the voice recognition may enable to recognize various types of receipt information and to form and display information of an addressee, information of a sender, mail information, and payment information.

Thus, the mail receipt apparatus builds various voice feature vector databases and various information databases for acquiring the address information, the zip code information, the telephone number information, the mail information, and the payment information so that the mail receipt information can be easily acquired.

In this embodiment of the present invention, the processes (step S806 to step S814) are sequentially performed. However, it needs to be understood that the processes may be performed regardless of sequential order and only necessary information for mail receipt may be selectively acquired.

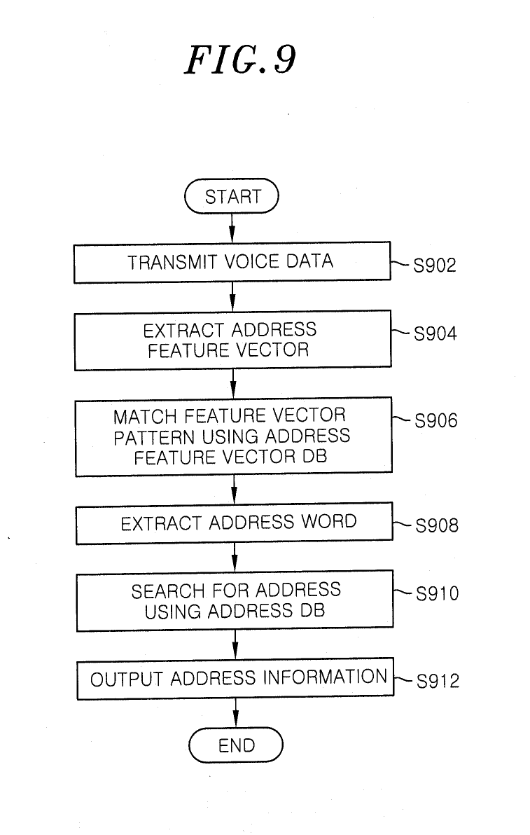

FIG. 9 is a flow chart illustrating acquisition of address information for receipt of mail in accordance with another embodiment of the present invention.

Referring to FIG. 9, a voice data for mail receipt is transmitted from the voice input block 100 to the receipt information recognition block 200 in step S902). Then, the address voice extractor 202a of the address acquisition unit 202 extracts the address voice feature vector from the voice data on an addressee or a sender that is transmitted from the voice input block 100 in step S904.

The address word pattern matching unit 202b of the address acquisition unit 202 separates the extracted address voice feature vector such as one word address voice feature vector, two words address voice feature vector, and three words address voice feature vector according to vocalization, and matches a pattern of the separated address voice feature vector in step S906). For example, a pattern of a corresponding address voice feature vector may be matched in the address feature vector database 202c including a street name feature vector, a street/district name feature vector, and a street/district/city (state) name feature vector according to the number of words.

Next, the address word extractor 202d of the address acquisition unit 202 extracts an address word such as a street (block) name, a street/district (block/area) name, a street/district/city (block/area/town) name according to the matched pattern in step S908. In a case of extracting the address word by referring to a street (block) name feature vector database, a plurality of same street (block) names may be extracted. When the address word is extracted by referring to a street/district (block/area) name feature vector database or a street/district/city (bock/area/town) name feature vector database, a unique single word may be extracted.

The address searching unit 202e of the address acquisition unit 202 searches for the extracted address word in the address information database 202f built by connecting address with zip code in step S910. Since the address information database 202f is built by connecting address with zip code, address and zip code may be searched for and extracted together.

Address information output unit 202g of the address acquisition unit 202 acquires the searched address as address information about an addressee or a sender and outputs the acquired address information to the receipt information recognizer 212 in step S912. The acquired address information is displayed to allow a mail receipt staff to confirm so that more precise address information may be acquired.

Thus, the address information may be effectively acquired from the input voice data by extracting the voice feature vector from the input voice data, by extracting the address word using the address feature vector database according to words, and by searching for the extracted address word in the address information database to acquire the address information.

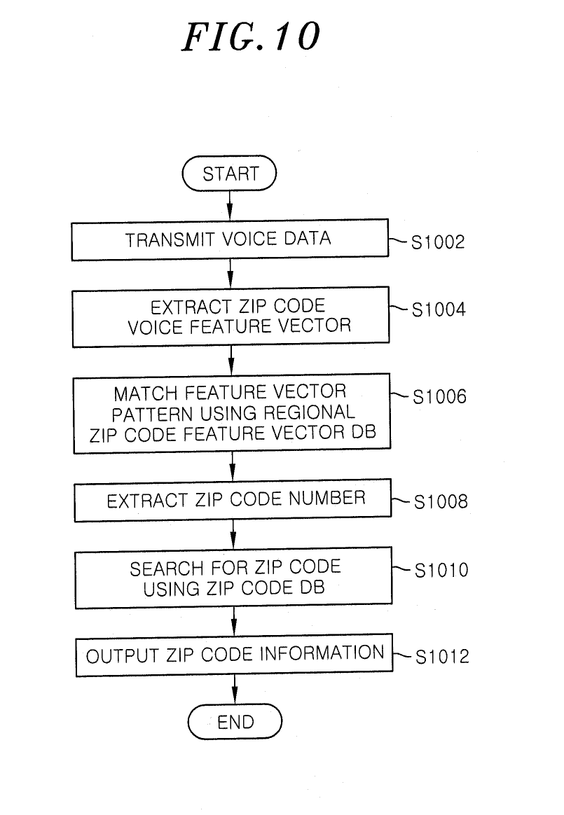

FIG. 10 is a flow chart illustrating acquisition of zip code information for receipt of mail in accordance with still another embodiment of the present invention.

Referring to FIG. 10, a voice data for mail receipt is transmitted from the voice input block 100 to the receipt information recognition block 200 in step S1002. Then, the zip code voice extractor 204a of the zip code acquisition unit 204 extracts a zip code voice feature vector from the voice data on an addressee or a sender that is transmitted from the voice input block 100 in step S1004.

The zip code pattern matching unit 204b of the zip code acquisition unit 204 separates a first number of the extracted zip code voice feature vector, and matches a pattern of the feature vector according to the separated first number of the zip code voice feature vector in step S1006. The pattern of the corresponding zip code voice feature vector is matched by classifying the extracted first number of the zip code voice feature vector by regions in the zip code feature vector database 204c. Here, the zip code feature vector database 204c includes, e.g., a Seoul feature vector, a Gangwon feature vector, a Chungcheong feature vector, a Gyeonin feature vector, a Jeolra feature vector, a Gyeongnam feature vector, a Gyeongbuk feature vector and the like. For example, ‘1’ is assigned to Seoul region, ‘2’ is assigned to Gangwon region, ‘3’ is assigned to Chungcheong region, ‘4’ is assigned to Gyeongin region, ‘5’ is assigned to Jeolra region, ‘6’ is assigned to Gyeongnam region, and ‘7’ is assigned to Gyeongbuk region.

Next, the zip code number extractor 204d of the zip code acquisition unit 204 extracts the regional zip code number according to the matched pattern in step S1008. In this case, about five numbers of zip codes having high similarities may be extracted.

The zip code searching unit 204e of the zip code acquisition unit 204 searches for a zip code in the zip code information database built by connecting a zip code with an address using the extracted number in step S1010. Since the zip code information database 204f is built by connecting a zip code with an address, the zip code may be searched for and extracted together with the address.

The zip code information output unit 204g of the zip code acquisition unit 204 acquires the searched zip code as zip code information about an addressee or a sender and outputs the acquired zip code information to the receipt information recognizer 212 in step S1012. When the acquired zip code information is display to allow a mail receipt staff to confirm, more precise zip code information may be acquired.

Thus, the voice feature vector is extracted from the input voice data, the zip code number is extracted using the regional feature vector database, and the extracted zip code number is searched in the zip code information database to acquire the zip code information so that the zip code information can be effectively acquired from the input voice data.

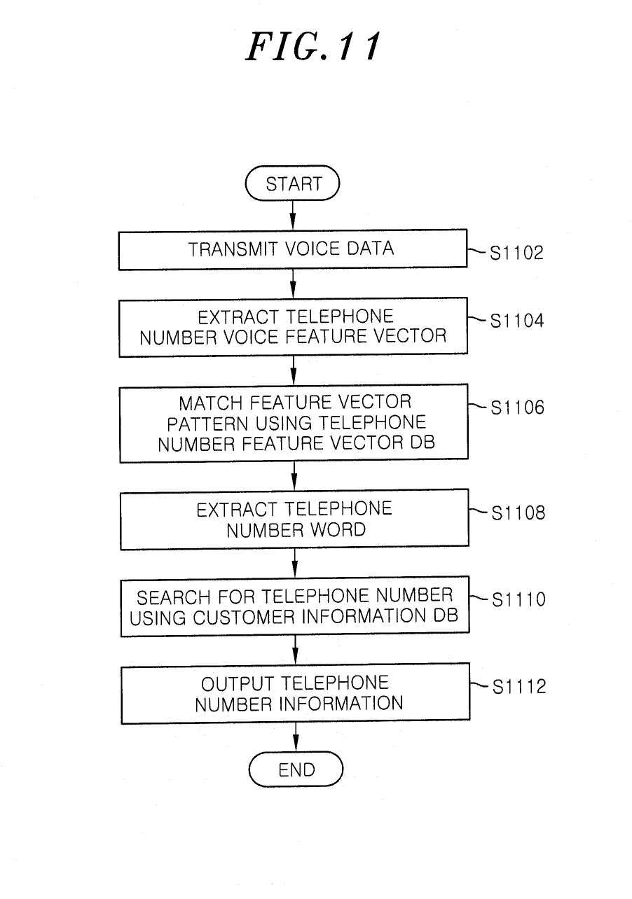

FIG. 11 is a flow chart illustrating acquisition of a telephone number for receipt of mail in accordance with still another embodiment of the present invention.

Referring to FIG. 11, the voice data from the mail receipt is transmitted from the voice input block 100 to the mail receipt information recognition block 200 in step S1102). Then, the telephone number voice extractor 206a of the telephone number acquisition unit 206 extracts a telephone number voice feature vector from the voice data on an addressee of a sender that is transmitted from the voice input block 100 in step S1104.

The telephone number pattern matching unit 206b of the telephone number acquisition unit 206 separates the extracted telephone number voice feature vector into three word telephone number voice feature vectors and matches patterns of the separated telephone feature vectors in step S1106. For example, the pattern of the telephone number feature vector may be matched in the telephone number feature vector database 206c according to a corresponding word. For example, the region/mobile phone number may be classified into Seoul ‘02’, Gyeonggi ‘031’, Incheon ‘032’, Gangwon ‘033’, Chungnam ‘041’, Daejeon ‘042’, Chungbuk ‘043’, Busan ‘051’, Wulsan ‘052’, Daegu ‘053’, Gyeongbuk ‘054’, Gyeongnam ‘055’, Jeonnam ‘061’, Gwangju ‘062’, Jeonbuk ‘063’, Jeju ‘064’, and mobile phone ‘010, 011, 016, 017, and 019’.

Next, the telephone number word extractor 206d of the telephone number acquisition unit 206 extracts a telephone number word (number) including the region/mobile phone number, the area number, and the telephone number according to the matched pattern in step S1108. The telephone number word may be extracted in the form of ‘region/mobile phone number-area number-telephone number’. The first word of the telephone number word is used to distinguish a wire telephone from a wireless telephone. When the first word of the telephone number word is a regional number, the regional number word is extracted using a regional number feature vector database. Further, when the first word of the telephone number word is a number indicating a communication company or a mobile telephone communication company, a mobile phone number is extracted using a mobile phone feature vector database.

A second word of the telephone number word is used to distinguish an area number such that the area number may be extracted according to a three-digit word, a four-digit word, and the like. A third word of the telephone number word is used to distinguish the telephone number such that the telephone number may be extracted according to the four-digit word. Thus, the extracted region/mobile phone number-area number-telephone number may be used to several telephone numbers having relatively high similarities.

Next, the telephone number searching unit 206e of the telephone number acquisition unit 206 searches for the telephone number in the customer information database 206f including a customer name, a customer telephone number, and the other using the extracted telephone word in step S1110.

The telephone number information output unit 206g acquires the searched telephone number as telephone number information about an addressee or a sender and outputs the telephone number information to the acquired receipt information recognizer 212 in step 1112. When the acquired telephone number is displayed to allow a mail receipt staff to confirm, more precise telephone number information may be acquired.

Thus, the telephone number acquisition unit extracts the voice feature vector from the input voice data, extracts the telephone word (number) by numbers using the feature vector database, and searches for the telephone word in the customer information database to acquire the telephone number information so that the telephone number information may be effectively acquired from the input voice data.

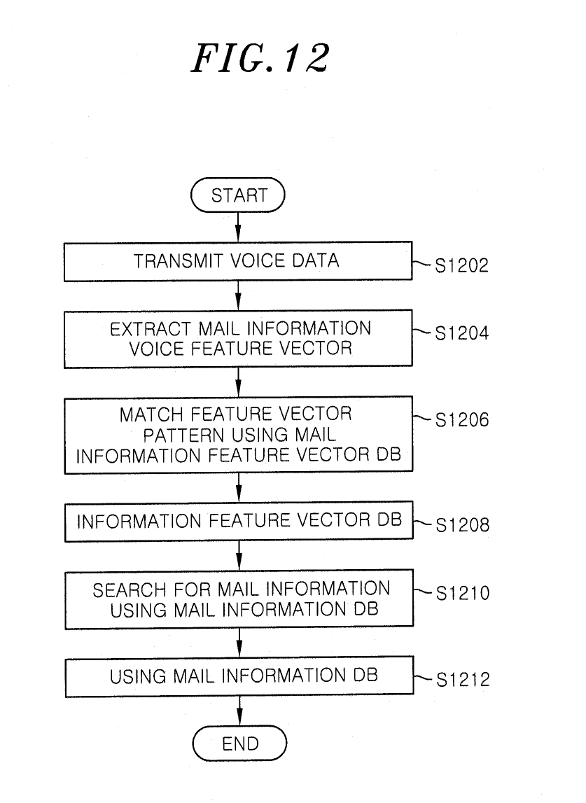

FIG. 12 is a flow chart illustrating acquisition of mail information for receipt of mail in accordance with still another embodiment of the present invention.

Referring to FIG. 12, the voice data for the mail receipt is transmitted from the voice input block 100 to the receipt information recognition block 200 in step S1202. Then, the mail information voice extractor 208a of the mail information acquisition unit 208 extracts a mail information voice feature vector from the voice data transmitted from the voice input block 100 in step S1204.

The mail information pattern matching unit 208b of the mail information acquisition unit 208 separates the extracted mail information voice feature vector into five words such as content of a package, a service type, weight, a size, and a delivery method, and matches a pattern of the separated mail information voice feature vector in step S1206. For example, the mail information pattern matching unit 208b may match the pattern of the mail information feature vector in the mail information feature vector database 208c including a package content feature vector, a service type feature vector, a weight feature vector, a size feature vector, and a delivery method feature vector according to a corresponding word. The mail information pattern matching unit 208b may match the pattern through the feature vectors on continuous voice data including package content, a service type, weight, a size, and a delivery method.

The mail information word extractor 208d of the mail information acquisition unit 208 extracts words related to the mail information including package content, a service type, weight, a size, and a delivery method according to the matched pattern in step S1208. The extracted words are displayed to allow a mail receipt staff to confirm so that a more precise word may be extracted.

The mail information searching unit 208e of the mail information acquisition unit 208 searches for a word related to the mail information in the mail information database 208f including package content, a service type, weight, a size, and a delivery method using the extracted word in step S1210.

The mail information output unit 208g of the mail information acquisition unit 208 acquires the searched word as the mail information and outputs the acquired mail information to the receipt information recognizer 212 in step S1212.

Thus, the voice feature vector is extracted from the input voice data, a word related to the mail information is extracted using the mail information feature vector database, and the mail information is acquired by searching for the extracted word in the mail information database so that the mail information may be effectively acquired from the input voice data.

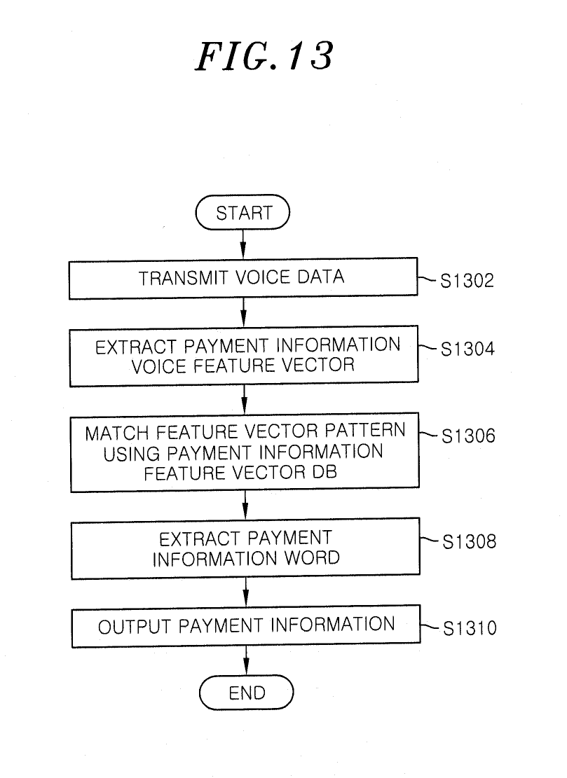

FIG. 13 is a flow chart illustrating acquisition of payment information for receipt of mail in accordance with still another embodiment.

Referring to FIG. 13, the voice data for the mail receipt is transmitted from the voice input block 100 to the receipt information recognition block 200 in step S1302. Then, the payment information voice extractor 210a of the payment information acquisition unit 210 extracts a payment information voice feature vector from the voice data transmitted from the voice input block 100 in step S1304.

The payment information pattern matching unit 210b of the payment information acquisition unit 210 matches a pattern of the extracted payment information voice feature vector including several words such as immediate payment, postpaid, subsequent payment, unpaid, and a credit card in step S1306. For example, the extracted payment information voice feature vector including several words such as immediate payment, postpaid, subsequent payment, unpaid, and a credit card may be matched according to a corresponding word in the payment information feature vector database 210c. Here, the payment information feature vector database 210c includes, e.g., an immediate payment feature vector, a postpaid feature vector, a subsequent payment feature vector, an unpaid feature vector, a credit card feature vector and the like.

The payment information word extractor 210d of the payment information acquisition unit 210 extracts a word related to the payment information including immediate payment, postpaid, subsequent payment, unpaid, and a credit card according to the matched pattern in step S1308. The extracted word is displayed to allow a mail receipt staff to confirm so that a more precise word may be extracted.

The payment information output unit 210e of the payment information acquisition unit 210 acquires the extracted word as the payment information and outputs the acquired payment information to the receipt information recognizer 212 in step S1310.

Thus, the payment information acquisition unit extracts the voice feature vector from the input voice data and acquires the payment information by extracting the word related to the payment information using the payment information feature vector database so that the payment information may be effectively acquired from the input voice data.

The embodiments of the present invention may be written as program commands to be executed by various devices such as a computer and recorded in medium readable by a computer. The medium may include program commands, a data file, a data structure, and combination thereof. This medium may be designed and configured for the present invention, or know well to the skilled in the computer software engineers.

The computer-readable recording medium may include a magnetic medium such as a hard disk, a floppy disk, and a magnetic tape, an optical medium such as a CD-ROM, a DVD, and the like, a magneto-optical medium such as a floptical disk, ROM, RAM, and a hardware device for storing and executing program commands such as a flash memory.

The medium may be a transmission medium for delivering carriers to carry signals to which program commands, a data structure, etc. are assigned, such as light, a metal wire, and a waveguide. The program commands may include machine language codes transformed by a compiler and high-level language codes executed by a computer using an interpreter.

While the invention has been shown and described with respect to the embodiments, it will be understood by those skilled in the art that various changes and modifications may be made without departing from the scope of the invention as defined in the following claims.

What is claimed is:

1. A mail receipt method based on voice recognition comprising:
receiving input voice data required for an mail receipt;
recognizing information on the mail receipt from the received input voice data; and
storing the recognized information on the mail receipt to complete the mail receipt.

2. The method of claim 1, wherein the information about the mail receipt includes address information, zip code information, telephone number information, mail information, and payment information.

3. The method of claim 2, further comprising:
extracting an address voice feature vector to acquire the address information from the input voice data;
matching patterns of the separated address voice feature vectors using an address feature vector database;
extracting an address word according to the matched patterns; and
searching and recognizing the address information corresponding to the extracted address word using a mail address database.

4. The method of claim 2, further comprising:
extracting a zip code voice feature vector from the input voice data to acquire the zip code information;
matching patterns of the extracted zip code voice feature vector using a regional zip code feature vector database;
extracting a zip code number according to the matched patterns; and
searching and recognizing the zip code information corresponding to the extracted zip code number using a zip code database.

5. The method of claim 4, wherein the zip code information includes zip code information of an addressee and a sender.

6. The method of claim 2, further comprising:
extracting a telephone number voice feature vector from the input voice data to acquire the telephone number information;
matching patterns of the extracted telephone number voice feature vector using a telephone number feature vector database;
extracting a telephone number according to the matched patterns; and
searching and recognizing the telephone number information corresponding to the extracted telephone number using a customer information database.

7. The method of claim 2, further comprising:
extracting a mail information voice feature vector from the input voice data to acquire the mail information;
matching patterns of the extracted mail information voice feature vector using a mail information feature vector database;
extracting a mail information word according to the matched patterns; and
searching and recognizing the mail information corresponding to the extracted mail information word using a mail information database.

8. The method of claim 2, further comprising:
extracting a payment information voice feature vector from the input voice data to acquire the payment information;
matching patterns of the extracted payment information voice feature vector using a payment information feature vector database;
extracting a payment information word according to the matched patterns; and
recognizing the extracted payment information word as payment information to output the recognized payment information.

9. A mail receipt apparatus based on voice recognition, comprising:
a voice input block for inputting voice for receipt of mail;
a receipt information recognition block for recognizing mail receipt information from a voice data transmitted from the voice input block; and
a receipt block for storing the recognized mail receipt information to perform mail receipt.

10. The apparatus of claim 9, wherein the receipt information recognition block comprises:
an address acquisition unit for acquiring address information included in the mail receipt information from the input voice data;
a zip code acquisition unit for acquiring zip code information included in the mail receipt information from the input voice data;
a telephone number acquisition unit for acquiring telephone number information included in the mail receipt information from the input voice data;
a mail information acquisition unit for acquiring mail information included in the mail receipt information from the input voice data; and
a payment information acquisition unit for acquiring payment information included in the mail receipt information from the input voice data.

11. The apparatus of claim 10, wherein the address acquisition unit comprises:
an address voice extractor for extracting an address voice feature vector from the address input voice data;
an address word pattern matching unit for matching patterns of the extracted address voice feature vector using an address feature vector database;
an address word extractor for extracting an address word according to the matched patterns;
an address searching unit for searching for the extracted address word in an address information database; and
an address information output unit for acquiring the searched address as the address information to output the acquired address information.

12. The apparatus of claim 10, wherein the zip code acquisition unit comprises:
a zip code voice extractor for extracting a zip code voice feature vector from a zip code input voice data on an addressee or a sender transmitted from the voice input block;
a zip code pattern matching unit for separating a first number of the extracted zip code voice feature vector, and matches a pattern of a corresponding zip code voice feature vector by classifying the extracted first number of the zip code voice feature vector by regions in the zip code feature vector database;
a zip code number extractor for extracting the number of a regional zip code according to the matched pattern;
a zip code searching unit for searching for a zip code in the zip code information database built by connecting the zip code with an address using the extracted number; and
a zip code information output unit for acquiring the searched zip code as zip code information about an addressee or a sender to output the acquired zip code information to a receipt information recognizer.

13. The apparatus of claim 10, wherein the telephone number acquisition unit comprises:
a telephone number voice extractor for extracting a telephone number voice feature vector from the telephone number input voice data on an addressee or a sender transmitted from the voice input block;
a telephone number pattern matching unit for separating the extracted telephone number voice feature vector into a plurality of words and matches patterns of the separated telephone feature vectors according to corresponding words in the telephone number feature vector database;
a telephone number word extractor for extracting a telephone number word (number) according to the matched pattern;
a telephone number searching unit for searching for the telephone number in a customer information database using the extracted telephone word; and
a telephone number information output unit for acquiring the searched telephone number as telephone number information about an addressee or a sender to output the telephone number information to the receipt information recognizer.

14. The apparatus of claim 10, wherein the mail information acquisition unit comprises:
a mail information voice extractor for extracting a mail information voice feature vector from mail information input voice data transmitted from the voice input block;
a mail information pattern matching unit for separating the extracted mail information voice feature vector into a plurality of words such as content of a package, a service type, weight, a size, and a delivery method to match a pattern of the separated mail information voice feature vector in the mail information feature vector database;
a mail information word extractor for extracting words related to the mail information according to the matched pattern;
a mail information searching unit for searching for a word related to the mail information in the mail information database using the extracted word; and
a mail information output unit for acquiring the searched word as the mail information to output the acquired mail information to a receipt information recognizer.

15. The apparatus of claim 10, wherein the payment information acquisition unit comprises:
a payment information voice extractor for extracting payment information voice feature vector from a payment information input voice data transmitted from the voice input block;
a payment information pattern matching unit for matching a pattern of the extracted payment information voice feature vector according to a corresponding word in a payment information feature vector database;
a payment information word extractor for extracting a word related to the payment information according to the matched pattern; and
a payment information output unit for acquiring the extracted word as the payment information to output the acquired payment information to a receipt information recognizer.
